(19) United States
(12) Patent Application Publication
(10) Pub. No.: US 2010/0058934 A1
(43) Pub. Date: Mar. 11, 2010

(54) Food Melter

(76) Inventor: Tony Reevell, Manchester (GB)

Correspondence Address: Tony Reevell, 64 Jackson Crescent, Manchester, M15 5AA, GB

(21) Appl. No.: 12/554,952

(22) Filed: Sep. 7, 2009

Related U.S. Application Data
(60) Provisional application No. 61/118,516, filed on Nov. 28, 2008.

(30) Foreign Application Priority Data
Sep. 9, 2008 (GB) 0816446.9

(51) Int. Cl. A47J 43/04

(52) U.S. Cl. 99/353

(57) ABSTRACT

A food melter 2 has an upper food container 4 and a lower water container 6. The food container 4 is a removable attachable lid for the water container 6. The water container 6 is a thermal insulator. The food melter 2 is configured such that, in use, hot water is poured into the water container 6, the food container 4 is connected to the water container 6, food is placed into the food container 4 and heat from the hot water is transferred through the food container 4 to melt the food.

### BACKGROUND OF THE INVENTION

1. Field of the Invention

The present invention relates to food melters. More particularly, but not exclusively, the present invention concerns disposable food melters.

2. Description of Related Art

A known method of melting food is to use indirect heating by placing the food into a container which in turn is then placed into a pan of heated water. The water is heated but remains at a temperature below its boiling point. The food container and food within the container is therefore heated at a reduced temperature compared to direct heating. The apparatus used in this method is commonly known as a water bath or bain-marie.

### BRIEF SUMMARY OF THE INVENTION

In one aspect of the present invention there is provided a food melter comprising an upper food container and a lower water container; wherein the food container is a removable attachable lid for the water container; the water container is a thermal insulator; and the food melter is configured such that, in use, hot water is poured into the water container, the food container is connected to the water container, food is placed into the food container and heat from the hot water is transferred through the food container to melt the food.

The advantages are: being able to remove the food container enables easier access to the water container; the food container can be cleaned more easily as a stand-alone part; the food container may be connected to the water container to keep the water inside the water container and prevent against spilling or scolding with the hot water should the food melter be knocked over; and the thermally insulated water container may ensure that heat is retained for longer and the walls of the container remain at a lower temperature so can be safely handled.

Suitably, the food container is connected to the brim of the water container. Suitably, the brim of the food container is connected to the brim of the water container. Suitably, the food container forms a water-tight seal with the water container.

The advantages are: the sealed water container ensures that the hot water is not spilled and that water vapour does not escape and condense inside the food container thereby contaminating the food in the food container; and connecting the water container and food container at the brims enables easy access to connect and disconnect the containers.

Suitably, the water container further comprises a water fill-mark. Suitably, the bottom of the food container is lower than the water fill-mark when the food container is connected to the water container. Suitably, the water fill-mark is formed on the inside of the water container. Suitably, the water fill-mark extends around the perimeter of the water container.

The advantages are: the water fill-mark may enable water to be added to the water container to the correct level, and the food container may be connected to the water container without causing the water to overflow; water can be added to the water container to a level that enables the food container to be partially submerged when connected to the water container, thereby giving greater heat transfer to the food container; the water level may be arranged such that the air gap in the water container is minimised thus minimising heat losses; and extending the water fill-mark around the water container enables the water fill-mark to be seen from above at any angle, facilitating the filling of the water container with water.

Suitably, the food melter further comprises an outer lid. Suitably, the outer lid is a thermal insulator. Suitably, the outer lid is a lid for the food container. Suitably, the outer lid is connected to the rim of the food container. Suitably, the outer lid forms an air-tight seal with the food container. Alternatively, the outer lid forms an air-tight seal with the water container. Suitably, the outer lid is peelable. Suitably, the outer lid is a heat-sealed foil lid.

The advantages are: the thermal insulation of the outer lid ensures that the heat loss is reduced and retained for a greater time to melt the food in the food container; if the outer lid seals the food container the food container may act as a stand alone part and different food containers containing different foods can be interchanged with the water container providing variation; and providing an air-tight seal may prolong the life of food sealed in the container.

Suitably, the food melter further comprises a first food. Suitably, the first food is stored in the food container. Suitably, the first food is stored in the sealed food container. Suitably, the first food has a mass of at least 30 g. Alternatively, the first food has a mass of at least 60 g. Alternatively, the first food has a mass of at least 100 g. Suitably, the first food is chocolate. Suitably, the chocolate comprises small pieces.

The advantages are: the food container may be pre-filled with food for convenience; and small pieces of chocolate have a larger surface area thereby making them easier to melt.

Suitably, the food melter further comprises a second food. Suitably, the second food is stored in the water container. Suitably, the second food is stored in the sealed water container.

The advantages are: the convenience for the user of having food provided; and the water container may provide a large storage space beneath the food container.

Suitably, the food melter is disposable. Suitably, the water container is made from coated paper. Alternatively, the water container is made from plastic. Suitably, the food container is made from plastic. Alternatively, the food container is made from metal foil.

The advantage of being disposable is that it is more convenient for the user since no washing of the food melter is required after use.

Suitably, the volume of the food container is at least 50 cm³. Alternatively, the volume of the food container is at least 75 cm³. Alternatively, the volume of the food container is at least 100 cm³.

Suitably, the depth of the food container is at least 2 cm. Alternatively, the depth of the food container is at least 3 cm. Alternatively, the depth of the food container is at least 4 cm.

Suitably, the food container further comprises a partition.

The advantage of a partition is that is enables foods to be separated in the food container without mixing, enabling different foods to be melted at the same time.

Suitably, the thermal conductivity of the water container is less than 0.1 Wm⁻¹K⁻¹. Alternatively, the thermal conductivity of the water container is less than 0.5 Wm⁻¹K⁻¹. Alternatively, the thermal conductivity of the water container is less than 1 Wm⁻¹K⁻¹.

Other features of the invention will be apparent from the description which follows.

### BRIEF DESCRIPTION OF THE SEVERAL VIEWS OF THE DRAWING

For a better understanding of the invention, and to show how exemplary embodiments may be carried into effect, reference will now be made to the accompanying drawings in which:

FIG. 1 is a perspective view of a food melter;

FIG. 2 is an exploded perspective view of the food melter of FIG. 1;

FIG. 3 is a side view of the food melter of FIG. 1;

FIG. 4 is an exploded side view of the food melter of FIG. 1;

FIG. 5 is a side view of a food melter having a water fill-mark;

FIG. 6 is a side view of a food melter having water, without the food container fitted to the water container;

FIG. 7 is a side view of a food melter having water, with the food container fitted to the water container;

FIG. 8 is a perspective view of a food container having an outer lid;

FIG. 9 is a side cross-sectional view of a food container having an outer lid;

FIG. 10 is an exploded side cross-sectional view of the food container of FIG. 9;

FIG. 11 is an exploded side cross-sectional view of a food container having an outer lid;

FIG. 12 is a side cross-sectional view of a food container having an outer lid fitted to the water container;

FIG. 13 is a perspective view of a food container of a food melter having a partition;

FIG. 14 is a side cross-sectional view of a food container of a food melter having an extended rim;

FIG. 15 is a side cross-sectional view of a food container of a food melter having a flat bottom; and

FIG. 16 is a side cross-sectional view of a food container of a food melter having straight edges.

### DETAILED DESCRIPTION OF THE INVENTION

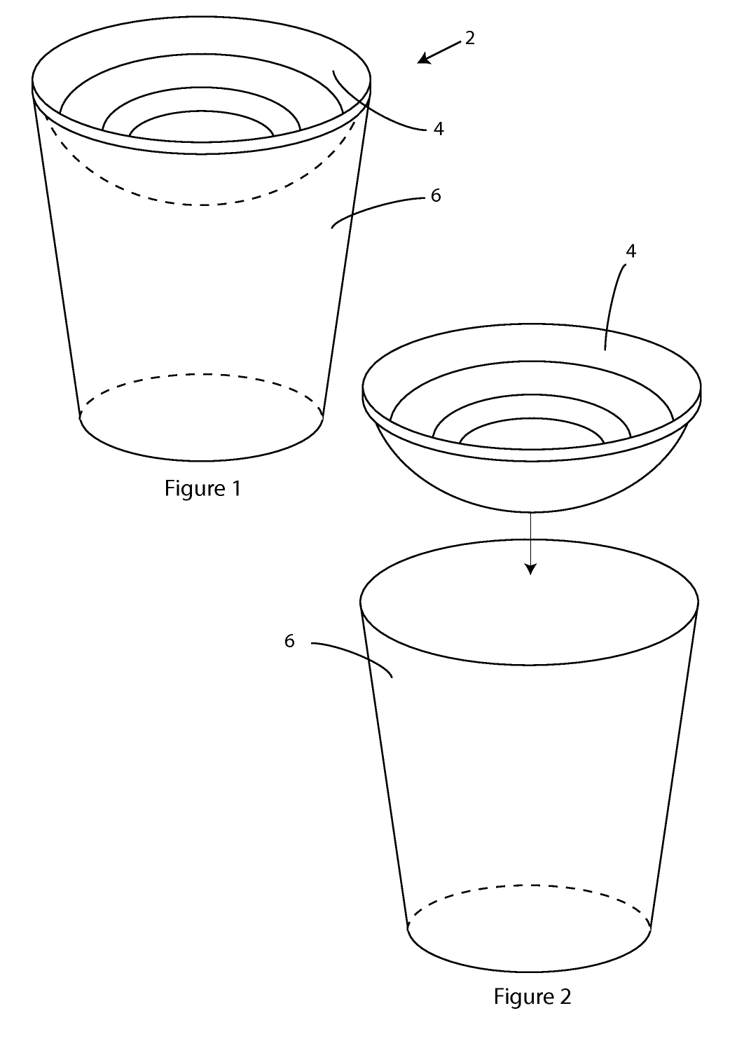

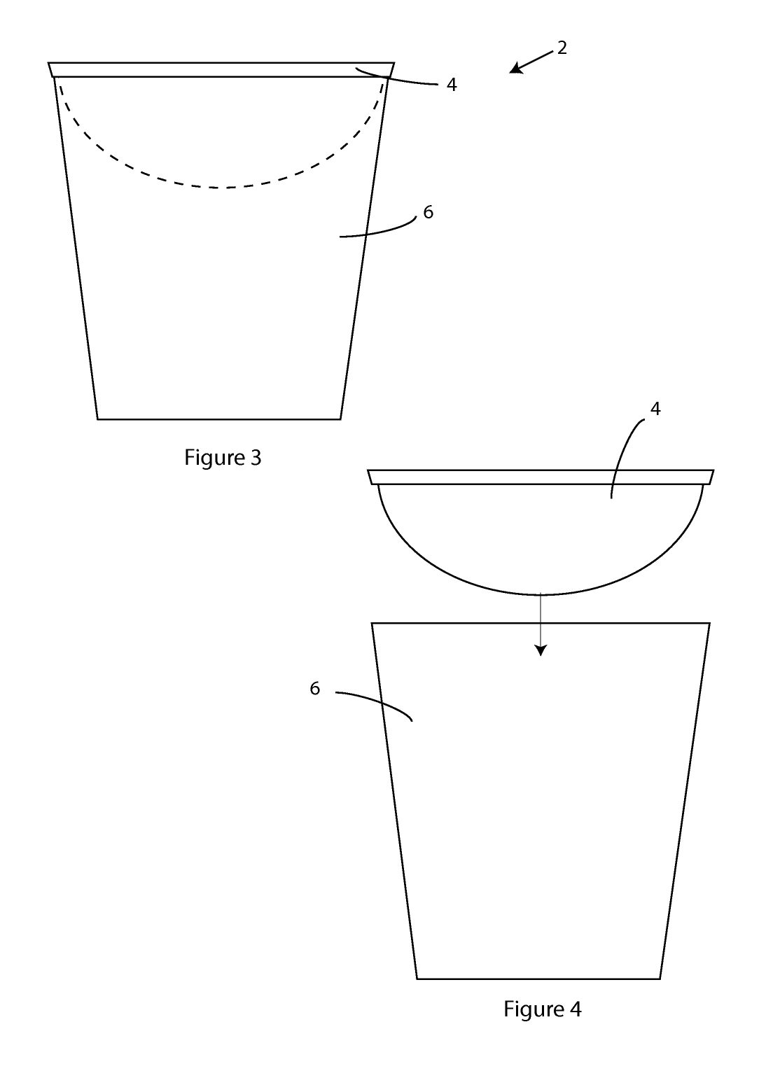

Referring to FIGS. 1-4 of the accompanying drawings, there is shown a food melter 2 comprising an upper food container 4 and a lower water container 6. The water container 6 is a waterproof container that is capable of holding hot water and has an opening. The food container 4 has a depression in which food can sit. In this embodiment, the water container 6 is cylindrical, with tapered sides and has a flat bottom so that it remains stable on a surface without tipping over. The food container 4 has a curved bottom and is hemispherical, also having an opening. The opening of the food container 4 is similar in size and shape to that of the water container 6. The depth of the water container 6 is greater than the depth of the food container 4 and the food container 4 fits into the water container 6 such that they are nested. The brim of the food container 4 can connect to the brim of the water container 6 and therefore the food container 4 acts as a lid for the water container 6.

In order to use the food melter 2 to melt food, firstly, water is heated to a high temperature by boiling point in a kettle or by other heating means. The hot water is then poured into the water container 6 and the food container 4 is fitted to the water container 6. The water container 6 is made from a material that provides good thermal insulation to conserve the heat within. The food container 4 is made from a material that has good thermal conducting properties to allow heat to pass through. A food that is to be melted is placed inside the food container 4. A typical food is chocolate. When chocolate is melted it is known as chocolate fondue so the device can also be described as a chocolate fondue device.

One of the properties of chocolate that makes it so enjoyable is that it melts in the mouth, at or around body temperature, approximately 40 degrees Celsius. Whilst the boiling point of water is 100 degrees Celsius, water begins to cool once the source of the heat is removed. However, the water still remains at a temperature above 40 degrees for tens of minutes, if heat losses are minimised, as it cools. Therefore, as the heat from the hot water in the water container 6 is transferred through the walls of the food container 4, the chocolate is melted by the heat. The user of the food melter 2 can expedite the melting of the chocolate by stirring the chocolate occasionally as it melts in order to ensure that the outer sections of chocolate receive heat when they are mixed in. The chocolate can also be in small pieces thereby maximising the surface area of the chocolate and further expediting the melting process.

As described above, the chocolate is melted by the transfer of heat through the food container 4. The heat can be transferred directly from the hot water to the food container 4 if the hot water is in contact with the food container 4, or indirectly by heating the air above the water and providing heated water vapour and steam which then transfers the heat to the food container 4. Because the food container 4 is connected to the water container 6 forming a lid, water vapour from the heated water does not escape and this therefore prevents the water vapour condensing as water inside the food container 4 and mixing with the chocolate which would be undesirable.

The food melter 2 can be made to different sizes depending on the amount of food that is to be melted and the number of people who will share the food. An embodiment will now be described for a food melter 2 where chocolate is the food to be melted and the food melter 2 is configured to have a single portion of food for a single user.

The water container 6 is made from waterproof coated paperboard and takes the form of a common paper coffee cup. Paper has a low thermal conductivity compared to other materials and therefore makes good insulating material. Typical values for thermal conductivities are: aluminium ˜200 Wm⁻¹K⁻¹; glass ˜1 Wm⁻¹K⁻¹; plastics ˜0.1-0.5 Wm⁻¹K⁻¹ and paper ˜0.05 Wm⁻¹K⁻¹. Paper coffee cups are available in standard sizes denoted by the amount of liquid that they can hold. Typical sizes are: 8 oz (225 ml); 12 oz (340 ml); 16 oz (455 ml) and 22 oz (625 ml). These cups are cylindrical with tapered sides in a downward direction and typically have an opening diameter of 90 mm and a base diameter of 60 mm. The height is then varied to vary the volume. Approximate heights are: 90 mm for 8 oz; 110 mm for 12 oz; 125 mm for 16 oz and 170 mm for 22 oz. Paper coffee cups can be double walled or triple walled for added heat insulation. In this embodiment, the water container 6 is a 12 oz double walled paperboard cup having opening diameter of 90 mm, base diameter of 60 mm and height 110 mm. The 12 oz paper coffee cup is a familiar shape to most coffee drinkers and will therefore have added aesthetic appeal for such users. It is also a convenient size to handle and large enough to contain sufficient hot water to melt the chocolate.

The food container 4 is made from plastic and contains a hemispherical depression. Common techniques for forming plastic containers include vacuum forming and injection moulding. The food container 4 is configured to connect to the water container 6 in a similar fashion to how a paper coffee cup lid connects to a paper coffee cup. In this way, the food container 4 is a releasable attachable lid for the water container 6. The food container 4 is configured such that the hemispherical depression holds the chocolate. The chocolate is in small pieces in order to increase the surface area of the chocolate and expedite melting, as will be described below. The food container 4 is configured such that the depression does not extent to the bottom of the water container 6, rather it does not penetrate far into the water container 6. Therefore the chocolate will sit and melt towards the top of the water container 6 and the resultant chocolate fondue will be easily accessible to the user. This also leaves a larger volume within the water container 6 below the food container 4 which can be used to place hot water. The larger the amount of hot water, the longer the heat will be retained.

The depth and radius of curvature of the food container 4 determine the volume and the amount of chocolate that the food container 4 can hold. In this embodiment the depth of the hemispherical food container is 40 mm, the radius is 40 mm and the volume is therefore approximately 130 cm³. The amount of chocolate pieces within the food container 4 for a single portion is 40 g.

In use, the user separates the food container 4 and water container 6 if they are connected and adds hot water to the water container 6. The user then fits the food container 4 to the water container 6 and adds the chocolate pieces to the food container 4. As the chocolate begins to melt, the user stirs the chocolate to facilitate melting. Once the chocolate is melted, the user can use the melted chocolate as a standard chocolate fondue by dipping various food items, such as marshmallows and fudge pieces, into the fondue to coat them with chocolate prior to eating.

In an embodiment where chocolate is the food to be melted and the food melter 2 is configured to be larger than the single-use embodiment described above, to allow for sharing with multiple users, the same principles as above will apply however the water container 6 and food container 4 dimensions will differ. In this embodiment the water container 6 will have a similar form to a paper cup but will have a larger opening diameter and base diameter. In this way, the water container 6 will be similar to a paper food bucket. The opening diameter is 150 mm, base diameter is 120 mm and height is 150 mm. The hemispherical food container 4 has a depth of 50 mm, a radius of 50 mm and therefore a volume of approximately 260 cm³. The amount of chocolate pieces within the food container 4 is 100 g. The use is the same as the use described above.

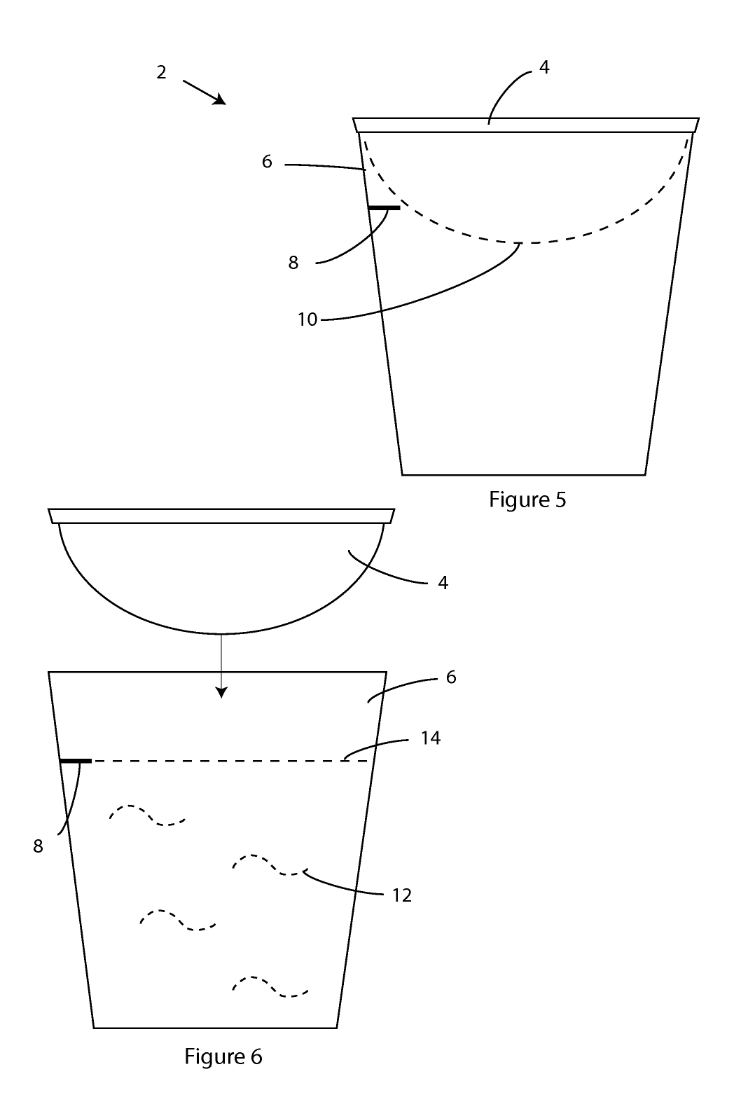

Referring to FIGS. 5-7 of the accompanying drawings, there is a shown a food melter 2 comprising a food container 4 and a water container 6. The water container 6 has a water fill-mark 8 and the food container 4 has a food container bottom 10. As already described above in relation to FIGS. 1-4, the food container 4 is a lid for the water container 6. FIG. 5 shows the food container 4 fitted to the water container 6. In this embodiment the food container bottom 10 is lower than the water fill-mark 8.

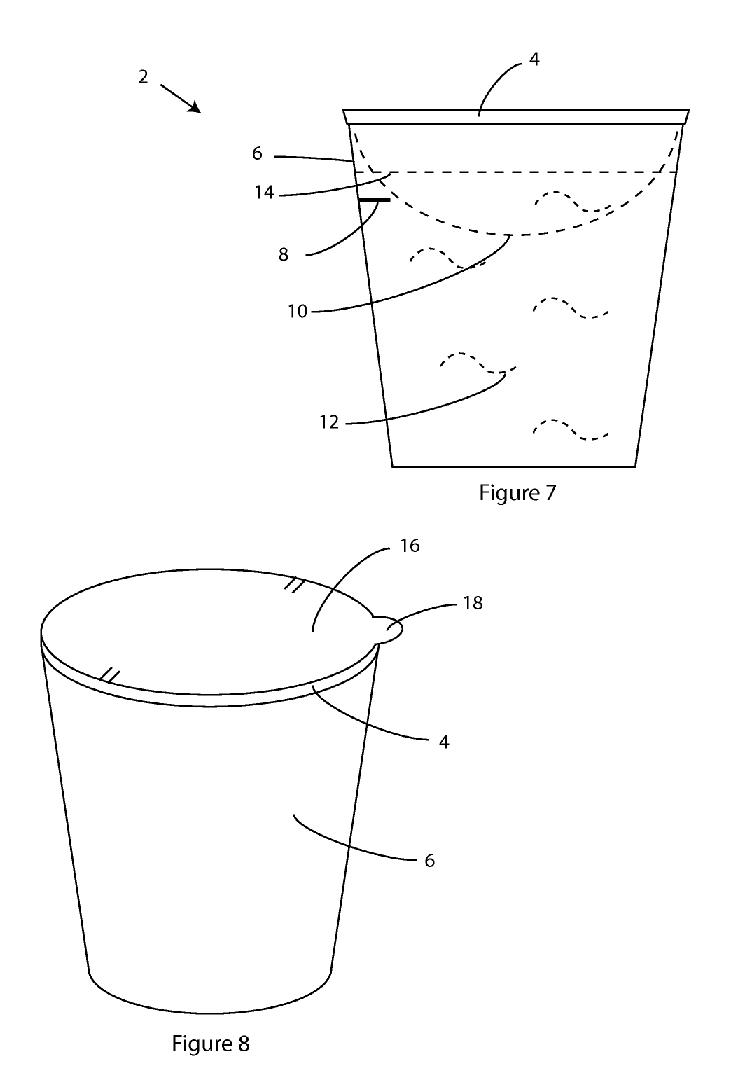

In use, the user separates the food container 4 and water container 6 if they are fitted together and pours hot water into the water container 6 up to the wall fill-mark 8. FIG. 6 shows the water container 6 separated from the food container 4 and the water container 6 having hot water 12 up to the water level 14 which is the same level as the water fill-mark 8. The user then fits the food container 4 to the water container 6. FIG. 7 shows the food container 4 fitted to the water container 6. The food container bottom 10 is partially submerged below the water level 14 causing the water level 14 to rise higher than the water fill-mark 8. The food melter 2 is configured such that the hot water 12 does not overflow from the water container 6 when the food container 4 is fitted to the water container 6. In this way, the hot water 12 surrounds the lower part of the food container 4 and heat is transferred from the hot water 12, through the food container 4 to the food within. This arrangement also minimises the air contained within the water container 6 above the water level 14 and therefore reduces heat losses. The water fill-mark 8 may be printed on or formed as part of the water container 6 and may extend around the perimeter of the water container 6 so that it is visible from above from any angle.

In another embodiment, the water fill-mark 8 is the same level or lower than the food container bottom 10 when the food container 4 is fitted to the water container 6. In this way, the food container bottom 10 is not submerged below the water level 14 and the water level 14 remains at the water fill-mark 8. Heat is then transferred to the food container 4 by the hot water 12 heating the air above the hot water 12 and by steam and water vapour that evaporates from the hot water 12.

Referring to FIG. 8 of the accompanying drawings, a food melter 2 is shown comprising a food container 4 fitted to a water container 6 is manner described above with reference to FIGS. 1-7. The food melter 2 further comprises an outer lid 16. The outer lid 16 is configured to seal the food container 4. In this embodiment the outer lid 16 is a heat-sealed foil lid having a lift tab 18. However, other outer lid configurations are also commonly available, some of which are described below.

In another embodiment the food melter 2 further comprises a first food and a second food. The first food is the food which is to be melted and is stored inside the food container 4 which is sealed with the outer lid 16. The outer lid 16 forms an air-tight seal thereby prolonging the shelf life of the first food. The first food is a food such as chocolate pieces. The second food is stored within the water container 6 which is sealed with the food container 4. The second food is a food such as marshmallow or fudge which a user can use with the melted chocolate fondue to coat with chocolate prior to eating. The water container 6 also contains an eating utensil such as a plastic fork or wooden skewer.

In use, the user separates the food container 4, which is sealed with the outer lid 16, from the water container 6. The user removes the contents of the water container 6, being the second food and the eating utensil, and adds hot water 12 to the water container 6. The food container 4 is then fitted to the water container 6 and the outer lid 16 is peeled from the food container 4 using the lift tab 18. Removing the outer lid 16 from the food container 4 after the food container 4 has been re-fitted to the water container 6 ensures that the first food within the food container 4 is not spilt or contaminated with water. The first food, such as chocolate, is melted in a manner already described above by the transfer of heat from the hot water 12 through the food container 4, expedited by the action of stirring. The user uses the eating utensil to dip the second food into the first food prior to eating. When the user has finished, the food melter 2 can be disposed of in the bin or washed and separated into parts to be recycled.

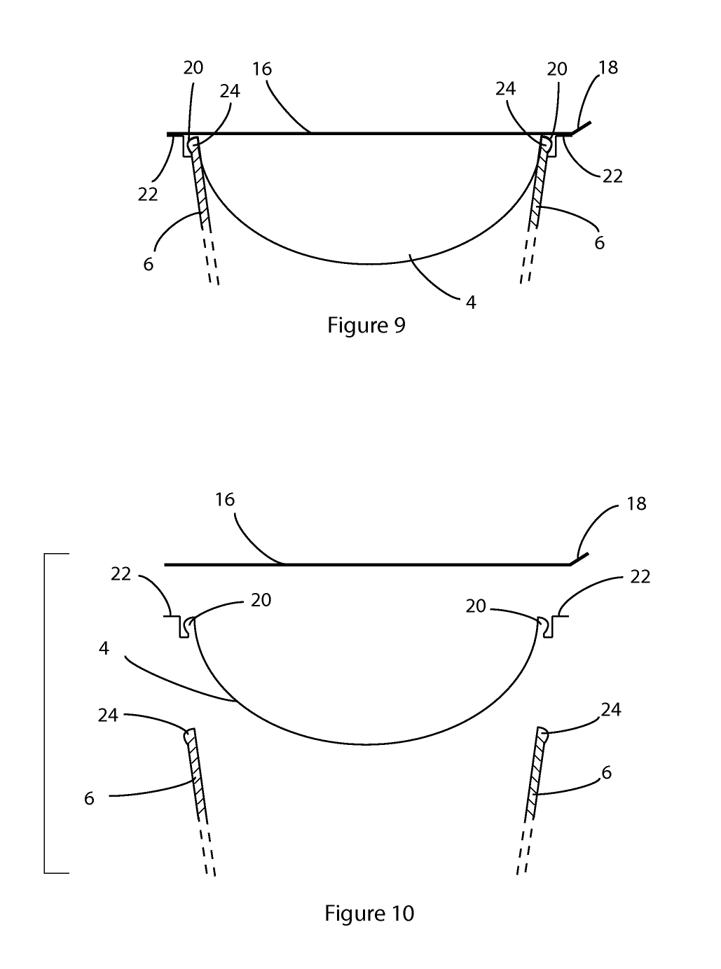

Referring to FIGS. 9 and 10 of the accompanying drawings, a food melter 2 comprises a food container 4, a water container 6 and an outer lid 16 having a lift tab 18. The food container 4 comprises a food container latching means 20 and a food container rim 22. The water container 6 comprises a water container rim 24. The food container 4 is a removable attachable lid for the water container 6. The food container latching means 20 extends around the perimeter of food container brim and connects to the water container rim 24 by having a curved hemmed portion that surrounds the water container rim 24. This latching arrangement is well known and is commonly used in coffee lids for paper coffee cups among other devices.

The outer lid 16 is a heat-sealable foil lid and is sealed around its perimeter to the food container rim 22 using a method involving pressure and heat. The food container rim 22 is a reinforced flange extending around the perimeter of the food container 4. In use, a first food is sealed within the food container 4 by the outer lid 16 and the food container 4 can be separated from the water container 6 without removing the outer lid 16.

In an alternative arrangement, the food container rim 22 forms part of the food container latching means by having a hemmed portion that has an upper edge that is also a reinforced flange, extending around the perimeter of the food container 4. The outer lid 16, being a heat-sealable foil lid, is then heat sealed to the rim.

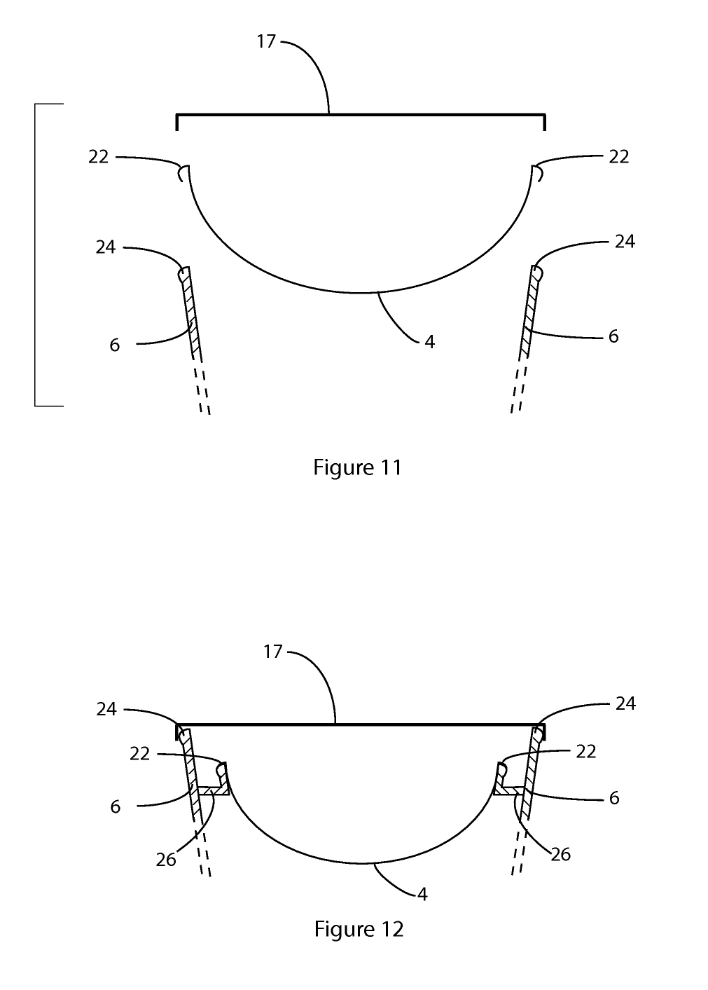

The embodiment in FIG. 11 shows a food melter 2 comprising a food container 4 having a press-on outer lid 17. The food container 4 is connected to the water container 6 by the means described above. The press-on outer lid 17 has a lip extending around the lid, downwardly perpendicular to the plane of the lid. The shape of the press-on outer lid 17 closely matches the shape of the food container rim 22 and the press-on outer lid 17 is configured such that the lip presses tightly around the food container rim 22, thereby securing the press-on outer lid 17 in place.

The embodiment in FIG. 12 shows a food melter 2 comprising a food container 4 fitted to a water container 6. In this embodiment, the food container 4 is connected to the brim of the water container by the food container rim 22 latching onto a water container inner rim 26. The water container inner rim 26 provides a rim within the water container 6 for the food container 4 to connect to and is similar to the water container rim 24, extending around the perimeter of the water container 4. In this way, the water container rim 24 located outside of the water container inner rim 26 is then connected to the press-on outer lid 17. The press-on outer lid 17 is a common lid used to seal containers.

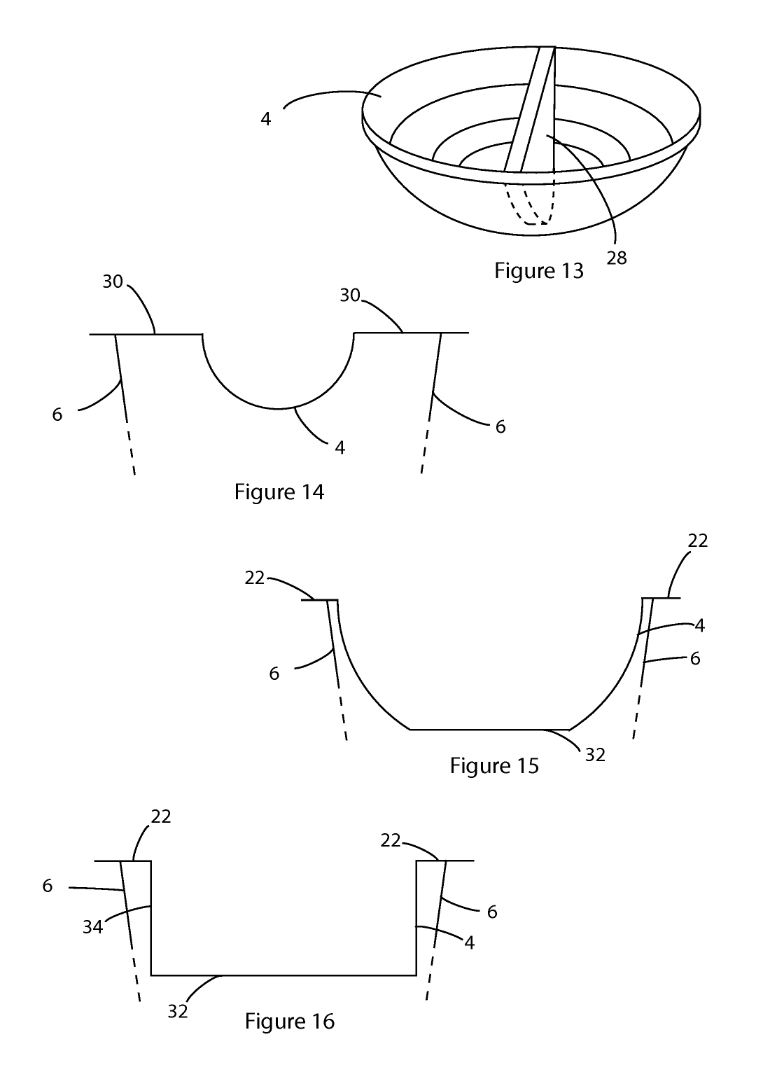

The embodiment in FIG. 13 shows a food container 4 comprising a partition 28. The partition 28 is configured to divide the food container 4 such that, in use, different foods can be placed as either side of the partition 28 and remain segregated as they are melted. The partition 28 therefore prevents the different foods at either side of the partition 28 from mixing. As described above, a typical food to be melted is chocolate. Chocolate is available in a number of different flavours such as milk chocolate, white chocolate, dark chocolate, mint chocolate, toffee chocolate etc. The partition 28 enables different types of chocolate to be held in the food container 4 e.g. milk chocolate on one side of the partition 28 and white chocolate on the other. This creates a more attractive product for the user who then has a choice of melted chocolate fondues.

The partition 28 runs down the centre of the food container 4 when viewed from above and extends from the food container bottom 10 to the level of the brim where the outer lid 16 is attached. In this way, different foods can be stored at either side of the partition 28 and are contained in the respective partitioned section by the outer lid 16. The partition 28, having an upper edge which is level with the brim of the food container 4, also acts as an added support for the outer lid 16. This is particularly useful where the outer lid 16 is a heat-sealed foil lid which is typically thin and flexible. A partition could also be configured to separate the food container into three of more separate containment areas.

Referring to FIGS. 14-16 of the accompanying drawings, a number of different profile shapes for food containers 4 are shown. Whilst the above description refers to a food container 4 having a hemispherical depression to hold the food, other shapes of food container 4 can also be utilised.

FIG. 14 shows a food container 4 comprising an extended rim 30. The extended rim 30 extends around the perimeter of the food container 4 and is extended in length in a horizontal planar radial direction towards the centre of the food container 4. The food container depression where the food is held therefore sits more towards a central axis of the food melter 2. In this way, the food container depression is moved away from the outer side of the water container 6 and, in use, allows more hot water to surround the food container bottom 10.

FIG. 15 shows a food container 4 comprising a flat bottom 32. The flat bottom 32 creates a larger surface area at the lowest point of the food container 4. In use, when hot water 12 surrounds the food container bottom 10, the larger food container surface area surrounded by water means that a larger surface area of food is in direct contact with the heat transfer surface expediting the melting process.

FIG. 16 shows a food container 4 comprising straight edges 34 and a flat bottom 32. This configuration maximises the volume of the food container 4 and therefore enables more food such as chocolate to be contained within the container.

In another embodiment, a food melter 2 is provided comprising a food container 4 that is configured to be a resealable lid for a standard paper coffee cup. In this way, the food container 4 retrofits onto a standard paper coffee cup and therefore a standard paper coffee cup can be used as a water container 6. In this embodiment the hot water 12 can be provided in the form of hot coffee, hot tea, hot chocolate, hot milk or any hot beverage with large water content. The food container 4 comprises a depression for holding food, and food such as chocolate is sealed within the food container by an outer lid 16. The outer lid 16 is a common lid such as a heat-sealed foil lid that can be peeled off, or a press-on outer lid 17. In use, hot water 12 or a hot water-based beverage is added to the standard paper coffee cup and the food container 4 is attached as a lid. The food such as chocolate is melted by the transfer of heat from the hot beverage below. A user can remove the food container 4 to drink the beverage and reapply the food container 4 to continue the melting process. Advantageously the food container has a flat bottom 32 in order to stand the container stably on a surface once removed from the water container 6. The user can remove the outer lid 16 from the food container 4 in order to access the melted food such as the chocolate fondue.

Although a few preferred embodiments have been shown and described, it will be appreciated by those skilled in the art that various changes and modifications might be made without departing from the scope of the invention, as defined in the appended claims. The food to be melted in the food melter is not restricted to chocolate and can include any food with a melting point lower that the temperature of the hot water, such as cheese or toffee. The food which is then dipped into the melted food is not restricted to marshmallows or fudge and can include any food which is used in a fondue such as breadsticks for cheese fondue. The water container is not limited to being made from paperboard material and can be made from other materials such as plastics and arrangements where an air or vacuum gap is provided between container walls to enhance thermal insulation. The food container is not limited to plastic and can be formed from other thermal conducting materials such metal or ceramics. The water container is not restricted to holding hot water and can include other liquids where water is the primary component of the mixture or solution such as hot beverages. The lid sealing methods are not restricted to those mentioned in the embodiments and can include other arrangements known to those skilled in the art such as glue-sealed peelable lids rather than heat-sealed peelable lids. The water container and food container should not be restricted to the sizes, dimensions and shapes mentioned in the embodiments, rather, the person skilled in the art would realise that other values could be suitable such as an ogive shape for the food container or a cuboid shape for the water container.

1. A food melter comprising:
an upper food container;
a lower water container;
wherein the food container is a removable attachable lid for the water container;
the water container is a thermal insulator; and
the food melter is configured such that, in use, hot water is poured into the water container, the food container is connected to the water container, food is placed into the food container and heat from the hot water is transferred through the food container to melt the food.

2. The food melter of claim 1, wherein the food container is connected to the brim of the water container.

3. The food melter of claim 2, wherein the brim of the food container is connected to the brim of the water container.

4. The food melter of claim 1, wherein the food container forms a water-tight seal with the water container

5. The food melter of claim 1, wherein the water container further comprises a water fill-mark.

6. The food melter of claim 5, wherein the bottom of the food container is lower than the water fill-mark when the food container is connected to the water container.

7. The food melter of claim 5, wherein the water fill-mark is formed on the inside of the water container.

8. The food melter of claim 5, wherein the water fill-mark extends around the perimeter of the water container.

9. The food melter of claim 1, further comprising an outer lid.

10. The food melter of claim 9, wherein the outer lid is a thermal insulator.

11. The food melter of claim 9, wherein the outer lid is a lid for the food container.

12. The food melter of claim 9, wherein the outer lid forms an air-tight seal with the food container.

13. The food melter of claim 9, wherein the outer lid forms an air-tight seal with the water container.

14. The food melter of claim 1, wherein the water container is made from plastic.

15. The food melter of claim 1, wherein the food container is made from plastic.

16. The food melter of claim 1, wherein the volume of the food container is at least 50 cm³.

17. The food melter of claim 1, wherein the depth of the food container is at least 2 cm.

18. The food melter of claim 1, wherein the food container further comprises a partition.

19. The food melter of claim 1, wherein the thermal conductivity of the water container is less than 1 Wm⁻¹K⁻¹.
